(19) United States
(12) Patent Application Publication
(10) Pub. No.: US 2026/0260393 A1
(43) Pub. Date: Sep. 3, 2026

(54) IMAGE GENERATION METHOD, ELECTRONIC DEVICE, AND NON-TRANSITORY COMPUTER-READABLE STORAGE MEDIUM

(71) Applicant: Douyin Vision Co., Ltd., Beijing (CN)

(72) Inventors: Xinzhou XIE, Beijing (CN); Xin JIANG, Beijing (CN); Jiamin ZHANG, Beijing (CN); Rongqiang HUANG, Beijing (CN); Wenchang HUANG, Beijing (CN)

(21) Appl. No.: 19/395,457

(22) Filed: Nov. 20, 2025

(30) Foreign Application Priority Data
Mar. 3, 2025 (CN) 202510246246.5

(51) Int. Cl. G06T 11/00; G06F 40/279

(52) U.S. Cl. CPC G06T 11/00; G06F 40/279

(57) ABSTRACT

The present disclosure provides an image generation method and apparatus, and a related product. The method includes: acquiring an image generation request for a first text, where the first text is a text related to an electronic book; in response to the image generation request, determining a target object described in the first text, and acquiring a second text related to the target object in the electronic book; and generating image generation prompt information according to the first text and the second text, and generating an image matching the first text according to the image generation prompt information.

### CROSS-REFERENCE TO RELATED APPLICATION

This application claims the priority to and benefits of the Chinese Patent Application No. 202510246246.5, which was filed on Mar. 3, 2025. The aforementioned patent application is hereby incorporated by reference in its entirety.

### TECHNICAL FIELD

The present disclosure relates to the field of computer technologies, and in particular, to an image generation method, an electronic device, and non-transitory computer-readable storage medium.

### BACKGROUND

In the related art, AI (Artificial Intelligence) technology may be used to assist a user in generating a required image. For example, the user inputs description information of an image to be generated into an image generation model that is trained based on the AI technology, and the image generation model generates an image based on the description information. Considering that in a scenario where a user reads an electronic book, there is a need to generate an image for related content of the electronic book, how to efficiently and accurately generate an image for the related content of the electronic book becomes one of the problems that need to be solved.

### SUMMARY

Embodiments of the present disclosure provide an image generation method, an electronic device, and non-transitory computer-readable storage medium.

An embodiment of the present disclosure provides an image generation method, including:

acquiring an image generation request for a first text, where the first text is a text related to an electronic book;

in response to the image generation request, determining a target object (for example, a first object) described in the first text, and acquiring a second text related to the target object in the electronic book; and

generating image generation prompt information according to the first text and the second text, and generating an image matching the first text according to the image generation prompt information.

An embodiment of the present disclosure provides an image generation apparatus, including:

a request acquiring unit, configured to acquire an image generation request for a first text, where the first text is a text related to an electronic book;

a text acquiring unit, configured to, in response to the image generation request, determine a target object (for example, a first object) described in the first text, and acquire a second text related to the target object in the electronic book; and

an image generation unit, configured to generate image generation prompt information according to the first text and the second text, and generate an image matching the first text according to the image generation prompt information.

An embodiment of the present disclosure provides an electronic device, including: at least a processor; and a memory configured to store computer-executable instructions, where the computer-executable instructions, when executed, cause the processor to implement the above method.

An embodiment of the present disclosure provides a non-transitory computer-readable storage medium, where the computer-readable storage medium is used to store computer-executable instructions, and the computer-executable instructions, when executed by a processor, implement the above method.

An embodiment of the present disclosure provides a computer program product, including a computer program, where the computer program, when executed by a processor, implements the above method.

### BRIEF DESCRIPTION OF DRAWINGS

In order to more clearly describe the technical solutions in one or more embodiments of the present disclosure or in the related art, the following briefly introduces the drawings that need to be used in the description of the embodiments or the related art. Obviously, the drawings in the following description are merely some embodiments of the present disclosure. For those of ordinary skill in the art, other drawings may also be obtained based on these drawings without creative efforts;

FIG. 1 is a schematic flowchart of an image generation method according to an embodiment of the present disclosure;

FIG. 2 is a schematic diagram of a first text according to an embodiment of the present disclosure;

FIG. 3 is a schematic diagram of a first text according to another embodiment of the present disclosure;

FIG. 4 is a schematic diagram of an image generation scenario according to an embodiment of the present disclosure;

FIG. 5 is a schematic diagram of an image generation result according to an embodiment of the present disclosure;

FIG. 6 is a schematic diagram of a custom image generation scenario according to an embodiment of the present disclosure;

FIG. 7 is a schematic diagram of generating an image matching a first text based on an existing image of an electronic book according to an embodiment of the present disclosure;

FIG. 8 is a schematic diagram of a structure of an image generation apparatus according to an embodiment of the present disclosure; and

FIG. 9 is a structural schematic diagram of an electronic device according to an embodiment of the present disclosure.

### DETAILED DESCRIPTION

In order for persons skilled in the art to better understand the technical solutions in one or more embodiments of the present disclosure, the technical solutions in one or more embodiments of the present disclosure are clearly and completely described below with reference to the drawings in one or more embodiments of the present disclosure. It is clear that the described embodiments are merely some rather than all of the embodiments of the present disclosure. All other embodiments obtained by persons of ordinary skill in the art based on one or more embodiments of the present disclosure without creative efforts shall fall within the scope of protection of the present disclosure.

It may be understood that before the use of the technical solutions disclosed in the embodiments of the present disclosure, the type of information involved in the present disclosure, the range of use, the use scenarios, etc. shall be informed to the relevant parties and the authorization of the relevant parties shall be obtained in an appropriate manner in accordance with relevant laws and regulations.

For example, in response to an active request from a user, prompt information is sent to the user to clearly inform the user that the requested operation will require access to and use of personal information of the user. In this way, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to the active request from the user, the prompt information may be sent to the user in the form of, for example, a pop-up window, in which the prompt information may be presented in text. Furthermore, the pop-up window may also include a selection control for the user to choose whether to "agree" or "disagree" to provide the personal information to the electronic device.

It may be understood that the above process of notifying and obtaining user authorization is only illustrative and does not constitute a limitation on the implementations of the present disclosure, and other manners that satisfy the relevant laws and regulations may also be applied to the implementations of the present disclosure.

Embodiments of the present disclosure provide an image generation method and apparatus, and a related product, which are able to efficiently and accurately generate a picture for related content of an electronic book. The image generation method may be applicable to a terminal device or a server-side and implemented by the terminal device or the server. The terminal device includes, but is not limited to, various types of user terminals, such as a notebook computer, a tablet computer, a desktop computer, a set-top box, a mobile device (for example, a mobile phone, a portable music player, a personal digital assistant, a dedicated messaging device, or a portable game device), a smartphone, a smart speaker, a smart watch, a smart television, and a vehicle-mounted terminal. The server includes a single server or a server cluster.

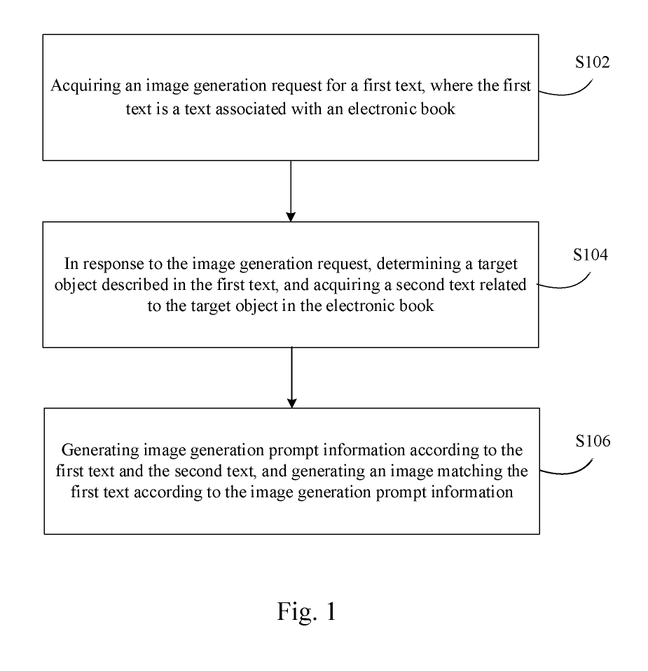

FIG. 1 is a schematic flowchart of an image generation method according to an embodiment of the present disclosure. As shown in FIG. 1, the process includes the following steps.

At step S102, an image generation request for a first text is acquired, where the first text is a text related to an electronic book;

At step S104, in response to the image generation request, a target object described in the first text is determined, and a second text related to the target object in the electronic book is acquired.

At step S106, image generation prompt information according to the first text and the second text is generated, and an image matching the first text according to the image generation prompt information is generated.

In the embodiments, first, the image generation request for the first text is acquired, where the first text is the text related to the electronic book; then, in response to the image generation request, the target object described in the first text is determined, and the second text related to the target object is acquired in the electronic book; and finally, the image generation prompt information is generated according to the first text and the second text, and the image matching the first text is generated according to the image generation prompt information. It may be seen that through the embodiments, the first text related to the electronic book may be acquired, the target object described in the first text may be determined, the second text related to the target object may be acquired in the electronic book, and the image matching the first text may be generated according to the first text and the second text, thereby achieving the effect of efficiently and accurately generating a picture for the related content of the electronic book.

In the above step S102, the first text is the text related to the electronic book, for example, the first text is the original text in the electronic book or the comment information for the electronic book from the user. In the embodiments, when the image generation operation of the user for the first text is detected, it is determined, based on the image generation operation, that the image generation request of the user for the first text is received. The image generation request is used to request to generate a matching image for the first text. The electronic book involved in the embodiments of the present disclosure may be any electronic book read through a reading application, which is not limited here.

In some embodiments, the image generation request for the first text is acquired by the following steps.

In response to a selection instruction for a body text part of the electronic book, selected content corresponding to the selection instruction is determined in the body text part.

in response to that a first request for generating an image based on the selected content is received, the selected content is determined as the first text, and the first request is determined as the image generation request for the first text.

In the embodiments, the user may select the body text part of the electronic book. In response to that the selection operation of the user for the body text part of the electronic book is detected, the selection instruction for the body text part of the electronic book is generated based on the selection operation. In response to the selection instruction, the selected content corresponding to the selection instruction is determined in the body text part of the electronic book, that is, the selected content of the user is determined in the body text part of the electronic book.

Next, in response to that the first request for generating an image based on the selected content is received, the selected content of the user is determined as the first text, and the first request is determined as the image generation request for the first text. For example, in response to that a trigger operation of the user for an image generation control corresponding to the selected content is detected, it is determined, based on the trigger operation, that the first request of the user for generating an image based on the selected content is received, the selected content of the user is determined as the first text, and the first request is determined as the image generation request for the first text.

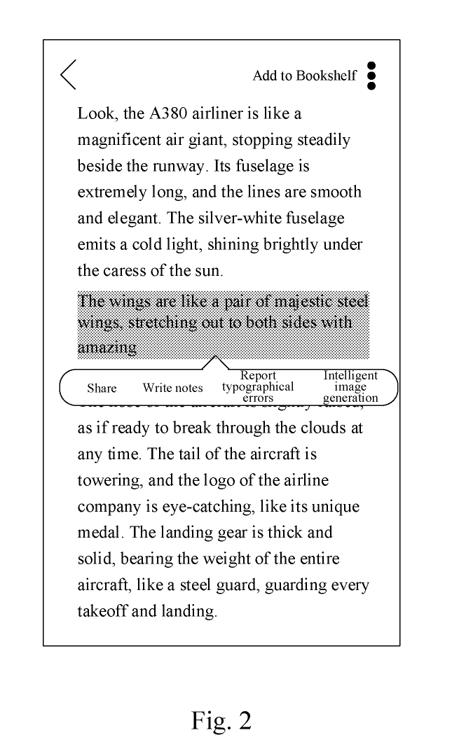

FIG. 2 is a schematic diagram of a first text according to an embodiment of the present disclosure. As shown in FIG. 2, the user may make a selection in the body text part of the electronic book by performing a touch-and-hold press. In response to the selection operation of the user, the content selected by the user is determined, and an "intelligent image generation" control corresponding to the selected content is displayed. When the user triggers the control, it is determined that the first request of the user for generating an image based on the selected content is received, the selected content is determined as the first text, and the first request is determined as the image generation request for the first text. In FIG. 2, the original text of the electronic book selected by the user is indicated by the shadow.

It may be seen that through the embodiments, the user may select the content of interest in the body text part of the electronic book and request to generate a matching image for the content of interest, thereby improving the e-book reading experience of the user and the image generation efficiency.

In some embodiments, the image generation request for the first text is acquired by the following steps.

In response to a comment information input instruction for the electronic book, comment information input for the electronic book is acquired.

When a second request for generating an image based on the comment information is received, the comment information is determined as the first text, and the second request is determined as the image generation request for the first text.

In the embodiments, the user may comment on the electronic book, for example, comment on a chapter or a paragraph in the electronic book. In response to that a comment information input operation of the user for the electronic book is detected, a comment information input instruction for the electronic book is generated based on the input operation. In response to the comment information input instruction, the comment information input by the user for the electronic book is acquired and displayed. The comment information input by the user for the electronic book may be comment information for the chapter of the electronic book or comment information for the paragraph of the electronic book.

Next, in response to that the second request for generating an image based on the comment information is received, the comment information input by the user is determined as the first text, and the second request is determined as the image generation request for the first text. For example, in response to that a trigger operation of the user for the image generation control corresponding to the input comment information is detected, it is determined, based on the trigger operation, that the second request for generating an image based on the comment information is received, the comment information input by the user is determined as the first text, and the second request is determined as the image generation request for the first text.

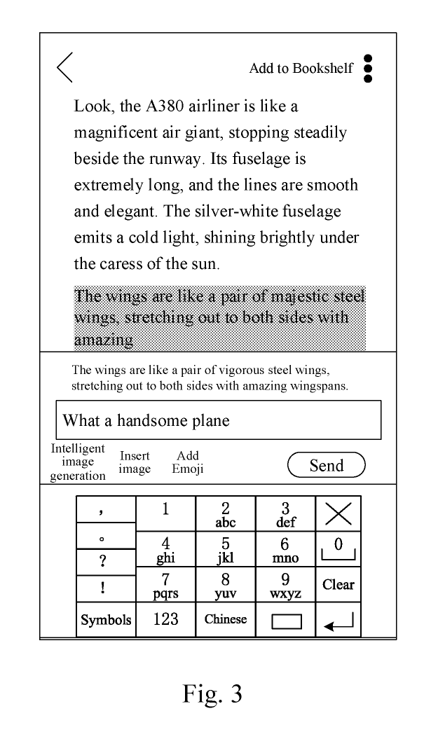

FIG. 3 is a schematic diagram of a first text according to another embodiment of the present disclosure. As shown in FIG. 3, the user may input comment information for a paragraph (indicated by the shadow in FIG. 3) in an electronic book. In response to the comment information input operation of the user, the comment information input by the user is displayed, and an "intelligent image generation" control corresponding to the comment information is displayed. In response to that the user triggers the control, it is determined that a second request for generating an image based on the comment information is received, the comment information input by the user is determined as the first text, and the second request is determined as the image generation request for the first text. In FIG. 3, the first text includes "What a handsome plane".

In some embodiments, referring to FIG. 3, after the user triggers a paragraph comment entry of the electronic book and enters a paragraph comment page, in response to that the user triggers the "intelligent image generation" control in the paragraph comment page without inputting the comment information, the paragraph (indicated by the shadow in FIG. 3) for which the user wants to post comment information may be acquired, the paragraph may be determined as the first text, and a matching image may be generated for the first text.

In some embodiments, referring to FIG. 3, after the user triggers the paragraph comment entry of the electronic book and enters the paragraph comment page, in response to that the user triggers the "intelligent image generation" control in the paragraph comment page while having entered comment information, the paragraph (indicated by the shadow in FIG. 3) for which the user wants to post comment information and the comment information input by the user may be determined as the first text, and a matching image may be generated for the first text.

It may be seen that through the embodiments, the user may comment on a chapter or a paragraph in the electronic book and request to generate a matching image for the input comment information, thereby improving the e-book reading experience of the user and the image generation efficiency.

In the above step S104, the target object described in the first text is determined in response to the image generation request. The first text has the described target object, and when the first text is the original text of the electronic book, the object described in the original text of the electronic book is determined as the target object. For example, the first text is the original text of the electronic book selected by the user: "With her big eyes, long black straight hair and extraordinary temperament, she amazed everyone." According to the content of the electronic book, it may be determined that the original text of the electronic book describes a character, little A, in the electronic book, and thus it may be determined that the target object is the character, little A.

When the first text is the comment information for the electronic book, in response to that the first text includes information indicating the described target object, the target object is determined based on the information; and in response to that the first text does not include the information indicating the described target object, the original text of the electronic book related to the first text is determined in the electronic book, and the target object is determined based on the content of the first text and the related original text of the electronic book. For example, the first text is comment information of the user for a paragraph in the electronic book: "I really want to beat little B up", and a character, little B, in the electronic book is determined as the target object. For another example, the first text is the comment information of the user for a paragraph in the electronic book: "This description is amazing, and the picture is vivid", a paragraph related to the comment information may be determined in the electronic book, and an object in the paragraph is determined as the target object.

Next, the second text related to the target object is also acquired in the electronic book. When the first text is an original text of the electronic book selected by the user, the second text may include a text related to the original text of the electronic book, and when the first text is comment information input by the user, the second text may include the paragraph or the chapter that the comment information is directed to.

In some embodiments, the second text related to the target object in the electronic book is acquired by the following steps.

A picture scene corresponding to the first text is determined, where the target object is in the picture scene.

In the electronic book, a first sub-text related to the picture scene and a second sub-text related to an object form of the target object in the picture scene are acquired, and the first sub-text and the second sub-text are determined as the second text.

It may be learned from the above description that the first text is the original text of the electronic book or the comment information for the electronic book. Whether the first text is the original text of the electronic book or the comment information for the electronic book, the second text may be determined in the following manners.

First, the picture scene corresponding to the first text is determined. When the first text is used to describe a picture scene, the picture scene corresponding to the first text includes the picture scene described in the first text. For example, the first text is the comment information for a paragraph: "I really want to beat little B up", and the picture scene corresponding to the first text includes a picture scene where little B is beaten up. The target object, as the object described in the first text, is located in the picture scene corresponding to the first text. In the above example, the target object is little B.

When the first text is not used to describe a picture scene, the picture scene corresponding to the first text includes the picture scene described in the original text of the electronic book related to the first text. For example, the first text is the comment information "This description is really wonderful", a paragraph related to the comment information is determined in the electronic book, and a picture scene described in the paragraph is determined as the picture scene corresponding to the first text. For example, the picture scene may be that multiple characters drink together. The target object, as the object described in the first text, is located in the picture scene corresponding to the first text. In the above example, the target object is each object in the picture scene described in the paragraph.

Next, the first sub-text related to the picture scene and the second sub-text related to the object form of the target object in the picture scene are acquired in the electronic book, and the first sub-text and the second sub-text are determined as the second text. The first sub-text may represent the specific content of the picture scene or the specific content of a scene related to the picture scene. The second sub-text may represent the object form of the target object in the picture scene or the object form of the target object in the related scene of the picture scene. The object form includes the appearance, clothing, hairstyle, posture, etc. of the target object.

Taking the first text being the comment information for a paragraph "I really want to beat little B up" as an example, the picture scene corresponding to the first text includes the picture scene where little B is beaten up, and thus the first sub-text related to the picture scene where little B is beaten up is acquired in the electronic book. The first sub-text may be a text describing that little B has an argument with another character. In addition, the second sub-text related to the object form of little B in the picture scene is acquired. The second sub-text may be a text describing the appearance and form of little B or a text describing the appearance and form of little B when little B has an argument with another character. The first sub-text and the second sub-text are determined as the second text.

Taking the first text being the comment information for a paragraph "This description is really wonderful" as an example. Because the picture scene corresponding to the first text includes the picture scene described in the paragraph, the paragraph may be acquired as the first sub-text. When the object form of each target object is described in the paragraph, the paragraph may also be acquired as the second sub-text, and the first sub-text and the second sub-text are determined as the second text.

Taking the first text being the original text of the electronic book selected by the user "With her big eyes, long black straight hair and extraordinary temperament, she amazed everyone" as an example, the picture scene corresponding to the first text is the scene where the character, little A, makes an appearance, and thus the first sub-text related to the appearance of the character, little A, is acquired in the electronic book, the second sub-text related to the appearance and form of the character, little A, when the character, little A, makes an appearance is acquired, and the first sub-text and the second sub-text are determined as the second text.

It may be seen that through the embodiments, when the first text has the corresponding picture scene, the picture scene corresponding to the first text may be determined, where the target object is in the picture scene. The first sub-text related to the picture scene and the second sub-text related to the object form of the target object in the picture scene may be acquired in the electronic book, and the first sub-text and the second sub-text may be determined as the second text, so that the meaning represented by the first text may be understood more deeply from the two aspects of the picture scene where the target object is located and the object form of the target object, thereby preparing for generating the image matching the first text.

In some embodiments, the second text related to the target object in the electronic book is acquired by the following steps.

A story plot corresponding to the first text is determined, where the target object is in the story plot.

In the electronic book, a third sub-text related to the story plot and a fourth sub-text related to behavior information of the target object in the story plot are acquired, and the third sub-text and the fourth sub-text are determined as the second text.

It may be learned from the above description that the first text is the original text of the electronic book or the comment information for the electronic book. When the first text is the original text of the electronic book and the original text of the electronic book is used to represent a story plot, or when the first text is the comment information published for the original text of the electronic book representing the story plot in the electronic book, the second text may be determined in the following manners.

First, the story plot corresponding to the first text is determined. When the first text is used to describe a story plot, the story plot corresponding to the first text includes the story plot described in the first text. For example, the first text is the original text of the electronic book, which is used to describe a story where multiple warriors look for a common enemy to take revenge together, and the story plot corresponding to the first text includes the story plot described in the original text of the electronic book. The target object, as the object described in the first text, is located in the story plot corresponding to the first text. In the above example, the target object includes multiple warriors and the enemy.

When the first text is not used to describe a story plot, the story plot corresponding to the first text includes the picture scene described in the original text of the electronic book related to the first text. For example, the first text is the comment information "This description is really wonderful", a paragraph related to the comment information is determined in the electronic book, and a story plot described in the paragraph is determined as the story plot corresponding to the first text. For example, the story plot may be a story where multiple warriors look for a common enemy to take revenge together. The target object, as the object described in the first text, is located in the story plot corresponding to the first text. In the above example, the target object includes multiple warriors and the enemy.

Next, the third sub-text related to the story plot and the fourth sub-text related to the behavior information of the target object in the story plot are acquired in the electronic book, and the third sub-text and the fourth sub-text are determined as the second text. The third sub-text may represent the specific content of the story plot. The fourth sub-text may represent the behavior information of the target object in the story plot. The behavior information includes dialogues, actions, etc.

Taking the first text being the original text of the electronic book, which is used to describe a story where multiple warriors look for a common enemy to take revenge together as an example, the third sub-text may include the original text of the electronic book and may also include other text content in the electronic book that describes the revenge story, and the fourth sub-text may include the original text of the electronic book and may also include other text content in the electronic book that describes the fighting process and dialogues of the target object in the revenge story.

It may be seen that through the embodiments, when the first text has the corresponding story plot, the story plot corresponding to the first text may be determined, where the target object is in the story plot. The third sub-text related to the story plot and the fourth sub-text related to the behavior information of the target object in the story plot may be acquired in the electronic book, and the third sub-text and the fourth sub-text may be determined as the second text, so that the meaning represented by the first text may be understood more deeply from the two aspects of the story plot where the target object is located and the behavior information of the target object, thereby preparing for generating the image matching the first text.

It is worth mentioning that in actual implementation, in one case, for any first text, the second text may be determined by determining the corresponding picture scene, and for the first text with a story plot, the second text may be determined by determining the corresponding story plot. In another case, whether the first text has the corresponding story plot may be first analyzed, where the story plot needs to include at least two factors: characters participating in the story and the story process. When the first text has the corresponding story plot, the second text may be determined by determining the corresponding story plot.

When the first text does not have the corresponding story plot, the second text may be determined by determining the corresponding picture scene.

After the second text is determined, in the above step S106, the image generation prompt information is generated according to the first text and the second text. The image generation prompt information is information used to be input to the image generation model to generate the image, and the image generation prompt information may also be referred to as an image generation prompt. The image generation model may be a painting model obtained by training based on AI technology, and the model may achieve automated generation of art works or image style migration and other operations by learning a large amount of image data and art style information. Furthermore, the image matching the first text is generated according to the image generation prompt information.

In some embodiments, generating the image generation prompt information according to the first text and the second text is performed by the following steps.

Through a large language model (LLM), element information of image elements is determined according to text content of the first text and text content of the second text, where the image elements include an object form of an object in a picture, an image scene environment, an image composition mode, an image style type and an image color hue.

Through the large language model, the image generation prompt information is generated according to the element information of the image elements.

In the embodiments, first, the element information of the image elements is determined through the large language model according to the text content of the first text and the text content of the second text, where the image elements include the object form of the object in the image, the image scene environment, the image composition mode, the image style type and the image color hue. The object in the image refers to a main object in the image to be generated, and the object in the image includes the target object determined above. The object form of the image in the picture includes the action, expression, appearance, clothing, etc. of the target object. The image scene environment refers to the background environment where the target object is located, such as in a fairyland or in a room. The image composition mode includes but is not limited to the aspect ratio of the image, the position of the target object in the image, etc. For example, the image style type may be ancient style, modern style, technology sense, cartoon sense, landscape, architecture, etc. The image color hue includes but is not limited to the main hue of the image to be generated, for example, the main hue is brownish yellow.

In an example, the object form of the target object may be determined according to the first text and the second sub-text, the image scene environment may be determined according to the first sub-text, and the image composition mode, the image style type and the image color hue matching the image scene environment may be determined.

Next, the image generation prompt information is generated through the large language model according to the element information of the image elements. For example, the element information of each of the image elements is used as the image generation prompt information through the large language model. The input of the large language model may be the first text and the second text, and the output of the large language model is the element information of each of the image elements, thereby facilitating the image generation model to generate the image according to the element information of each of the image elements.

It may be seen that through the embodiments, the semantic understanding ability of the large language model may be utilized to generate the image generation prompt information suitable for the image generation model to understand based on the first text and the second text, thereby improving the image generation efficiency.

In some embodiments, determining, through the large language model, the element information of the image elements according to the text content of the first text and the text content of the second text includes the following steps.

Through the large language model, text content for describing the image elements from the text content of the first text and the text content of the second text is extracted to obtain element information of at least one first image element in the image elements.

Through the large language model, for a second image element in the image elements for which the element information is not extracted, element information of the second image element is obtained by expanding based on the element information of the first image element and a book type of the electronic book.

In the embodiments, first, the text content for describing the image elements is extracted, through the large language model, from the text content of the first text and the text content of the second text to obtain the element information of at least one first image element in the image elements. Through this step, the element information of all the image elements may be extracted, or the element information of some image elements may be extracted. In response to that the element information of all the image elements is extracted, the large language model directly outputs the element information of all the image elements. In response to that the element information of some image elements is extracted, the large language model expands, for each second image element in the image elements for which the element information is not extracted, to obtain the element information of the second image element based on the element information of the first image element and the book type of the electronic book.

For example, the large language model extracts the specific description of the image scene environment from the first sub-text and extracts the object form of the target object from the first text and the second sub-text, and the large language model may further determine the image composition mode, the image style type and the image color hue according to the type of the electronic book (such as ancient romance, modern romance, etc.), the object form of the target object and the specific description of the image scene environment.

In a specific example, the first text is the original text of the electronic book selected by the user: "With her big eyes, long black straight hair and extraordinary temperament, she amazed everyone", the first sub-text is "Little A always walks in a fairy-like manner, and is always followed by four white maidens", and the second sub-text is "Although little A is young, a light gray whisk she carries with her and a suit of green clothes she wears make her look experienced and capable." In this example, the specific description of the image scene environment "fairy-like, four white maidens" may be extracted from the first sub-text, and the object form of the target object "big eyes, long black straight hair, extraordinary temperament, young, a light gray whisk, a suit of green clothes, experienced and capable" may be extracted from the first text and the second sub-text, and thus the large language model may further determine that the image composition mode is the composition mode with the figure as the main body, determine that the image style type is the immortal hero image, and determine that the image color hue is mainly white and light color, according to the type of the electronic book, ancient romance, the object form of the target object and the specific description of the image scene environment.

In yet another specific example, the first text is the comment information for a paragraph "I really want to beat little B up", the first sub-text is "When little B gets angry, his whole face blushes and he throws around things at hand", and the second sub-text is "Every time little B is beaten, he sheds tears in his left eye, for he has no tears in his right eye." In this example, the specific description of the image scene environment "things at hand being thrown around" may be extracted from the first sub-text, and the object form of the target object "being beaten, shedding tears in the left eye, blushing all over the face" may be extracted from the first text, the first sub-text and the second sub-text, and thus the large language model may further determine that the image composition mode is the composition mode with the figure as the main body, determine that the image style type is the indoor image, and determine that the image color hue is mainly black, white and gray, according to the type of the electronic book, funny reborn literature, the object form of the target object and the specific description of the image scene environment. The large language model may further expand the object form of the target object to include "being hit by a hammer head."

It may be seen that through the embodiments, the text content for describing the image elements may be first extracted from the text content of the first text and the text content of the second text to obtain the element information of at least one first image element in the image elements, and for the second image element in the image elements for which the element information is not extracted, the element information of the second image element may be obtained through expansion based on the element information of the first image element and the book type of the electronic book, so that the image generation prompt information contains the element information of all the image elements without being constrained by the first text from the user, thereby improving the matching degree between the generated image and the first text.

In the above step S106, the image matching the first text is generated according to the image generation prompt information. In some embodiments, the image generation prompt information may be input to the image generation model, and the image generation model generates the image matching the first text according to the image generation prompt information. In some embodiments, generating the image matching the first text according to the image generation prompt information includes the following steps.

Existing images of the electronic book are acquired, where the existing images include at least one of the following images: a cover image of the electronic book, an illustration image of the electronic book, a character image of the electronic book, a comic image of the electronic book, or an image in a related video of the electronic book;

Through the image generation model, a target image is determined from the existing images according to the image generation prompt information, where an image content of the target image is related to an image content prompted by the image generation prompt information.

Through the image generation model, the image matching the first text is generated according to the image generation prompt information and the target image.

In the embodiments, the existing images of the electronic book may be acquired in advance, and the existing images may be images generated for the electronic book by readers or users of the electronic book, including at least one of the following: the cover image of the electronic book, the illustration image of the electronic book, the character image of the electronic book, the comic image of the electronic book, or the image in the related video of the electronic book. The character image of the electronic book refers to an image generated for a character in the electronic book, the comic image of the electronic book refers to a comic work derived from the electronic book, and the image in the related video of the electronic book may be a video frame in a short video derived from the electronic book. The existing images of the electronic book may be stored in the image generation model in advance.

Then, the image generation prompt information is input to the image generation model, and the target image is determined, through the image generation model, from the existing images according to the image generation prompt information, where the image content of the target image is related to the image content prompted by the image generation prompt information. For example, the image generation prompt information is used to prompt to generate the appearance picture for the character, little A, and thus the character image of little A or the video frame where little A makes an appearance in the short video may be acquired as the target image.

Finally, the image matching the first text is generated, through the image generation model, according to the image generation prompt information and the target image.

It may be seen that through the embodiments, because the target image may be determined from the existing images of the electronic book and the target image may be used as an auxiliary parameter for image generation, the generated image may not only match the first text, but also be similar in style to the existing images of the electronic book, thereby improving the accuracy of image generation.

In some embodiments, generating, through the image generation model, the image matching the first text according to the image generation prompt information and the target image includes the following steps.

Through the image generation model, at least one of an object form of an object in the target image, an image scene environment of the target image, an image composition mode of the target image, an image style type of the target image, or an image color hue of the target image is determined as image reference information.

Through the image generation model, the image matching the first text is generated according to the image generation prompt information and the image reference information.

In the embodiments, first, at least one of the object form of the object in the target image, the image scene environment of the target image, the image composition mode of the target image, the image style type of the target image or the image color hue of the target image is identified through the image generation model as the image reference information. The more related the image content of the target image is to the image content prompted by the image generation prompt information, the more image reference information may be determined.

For example, the image generation prompt information is used to prompt to generate the appearance picture for the character, little A. In response to that the cover picture of the electronic book is acquired as the target image and little A is not in the cover picture, the image composition mode of the target image, the image style type of the target image and the image color hue of the target image may be acquired as the image reference information. In response to that the video frame where little A makes an appearance in the short video derived from the electronic book is acquired as the target image, the object form of little A in the target image, the image scene environment of the target image, the image composition mode of the target image, the image style type of the target image and the image color hue of the target image may be acquired as the image reference information.

Next, the image matching the first text is generated through the image generation model according to the image generation prompt information and the image reference information. When generating the image according to the image generation prompt information, the image generation model may refer to the style type, color hue, etc. of the target image, so that the generated image not only matches the first text, but also matches the style of the existing images of the electronic book.

In an example, a prompt may be input to the image generation model, where the prompt is used to inform the image generation model to use the image generation prompt information as a main image generation prompt and use the image reference information as an auxiliary image generation prompt for image generation. When the main image generation prompt conflicts with the auxiliary image generation prompt, the image generation model is set to evaluate the credibility of the main image generation prompt and the credibility of the auxiliary image generation prompt, and select a more credible prompt from the main image generation prompt and the auxiliary image generation prompt based on the credibility of the main image generation prompt and the credibility of the auxiliary image generation prompt. The credibility of the main image generation prompt is related to whether the main image generation prompt is directly extracted from the first text and the second text or obtained through expansion based on the book type. The credibility of the auxiliary image generation prompt is determined according to the user's interaction behavior with respect to the target image, for example, determined according to the number of likes given by the user to the target image.

It may be seen that through the embodiments, at least one of the object form of the object in the target image, the image scene environment of the target image, the image composition mode of the target image, the image style type of the target image or the image color hue of the target image may be referred to, and the image generation prompt information may be combined for image generation, thereby improving the accuracy of image generation.

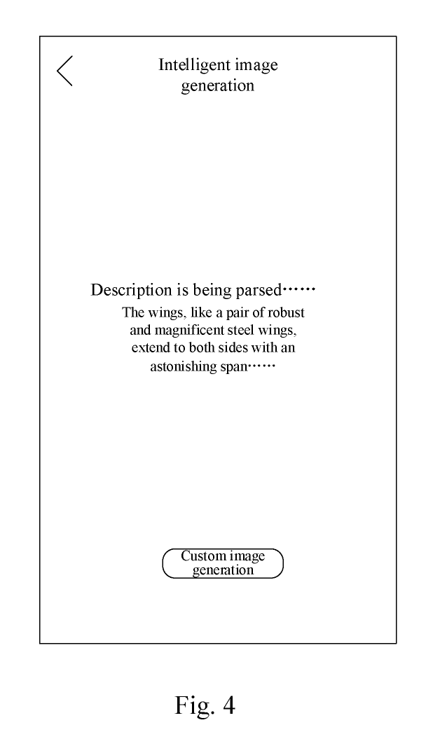

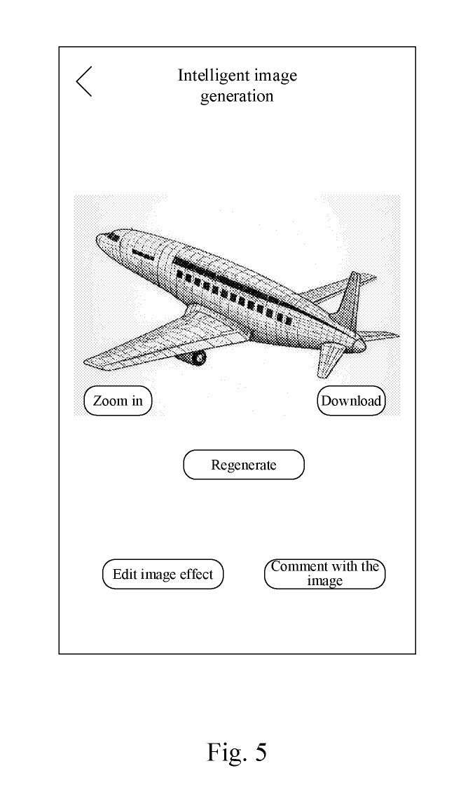

FIG. 4 is a schematic diagram of an image generation scenario according to an embodiment of the present disclosure. As shown in FIG. 4, provided that the user triggers the "intelligent image generation" control in FIGS. 2 or FIG. 3, the page shown in FIG. 4 is jumped to, and prompt information is displayed on the page to prompt the user that the required image is being generated by AI. FIG. 5 is a schematic diagram of an image generation result according to an embodiment of the present disclosure. As shown in FIG. 5, after the image generation by AI is finished, the image generated by AI may be displayed. Here, the generation of an image of an airplane is used as an example for illustration, and the appearance picture is generated by AI.

As shown in FIG. 5, the user may perform operations such as zooming in and downloading on the generated image, and the user may trigger the "comment with the image" control to copy the image to the comment area and post it as comment information. In an example, the generated image may be an emoticon package, and the user may copy the emoticon package to the comment area and post it. As shown in FIG. 5, the user may further trigger the "regenerate" control, and in response to the trigger operation, the process in FIG. 1 is re-executed to re-generate an image for the user. In order to improve the image generation efficiency, two images may be generated for the first text every time, and the user may switch each of the images by sliding horizontally.

Further, the above method process may further include the following steps.

In response to a custom image generation instruction for the first text, the first text and an image style type are displayed, where the image style type is determined based on the first text and a book type of the electronic book.

In response to a modification instruction for the first text and/or the image style type, an image matching the first text is generated according to the modified first text and/or the modified image style type.

Referring to FIGS. 4 and FIG. 5, in response to that the user triggers the "custom image generation" control in FIG. 4 or triggers the "edit image effect" control in FIG. 5, the custom image generation instruction for the first text is generated according to the trigger operation, and in response to the custom image generation instruction for the first text, the first text and the image style type are displayed, where the image style type is determined based on the first text and the book type of the electronic book. The book type may be, for example, ancient style, cultivating immortals style, etc.

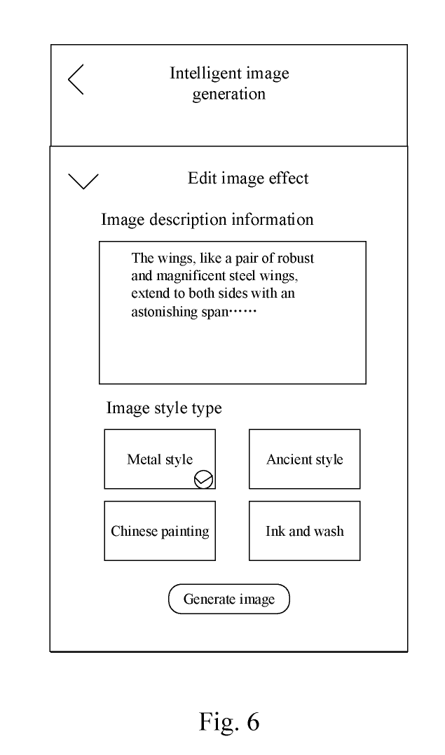

FIG. 6 is a schematic diagram of a custom image generation scenario according to an embodiment of the present disclosure. As shown in FIG. 6, in response to that the user triggers the "custom image generation" control in FIG. 4 or triggers the "edit image effect" control in FIG. 5, the page shown in FIG. 6 is jumped to, the first text (the original text of the electronic book selected by the user or the comment information input by the user) is displayed on the page, and the image style type determined based on the text content of the first text and the book type of the electronic book is displayed. The image style type may be different from the image style type determined according to the first text and the second text, and the image style type displayed here may be understood as the style type preliminarily determined by the large language model.

Next, in response that the modification operation of the user for the first text and/or the image style type is received, the modification instruction for the first text and/or the image style type is generated. According to the modification instruction, the modified first text and/or the modified image style type are acquired, and the image matching the first text is generated according to the modified first text and/or the modified image style type. In response that the user triggers the "generate image" control in FIG. 6, the scenario shown in FIG. 4 may be returned to for image generation.

In one case, when the user modifies the first text, the target object described in the modified first text may be determined through the process in FIG. 1, the updated second text related to the target object may be acquired in the electronic book, and the updated image generation prompt information may be generated according to the modified first text and the updated second text, where the image style type in the updated image generation prompt information is the image style type confirmed by the user in the scenario shown in FIG. 6. Next, the image matching the modified first text and the image style type confirmed by the user is generated according to the updated image generation prompt information.

In another case, when the user modifies the image style type, the target object described in the first text may be determined through the process in FIG. 1, the second text related to the target object may be acquired in the electronic book, and the updated image generation prompt information may be generated according to the first text and the second text, where the image style type in the updated image generation prompt information is the image style type obtained by the user through modification in the scenario shown in FIG. 6. Next, the image matching the first text and the image style type obtained by the user through modification is generated according to the updated image generation prompt information.

In yet another case, when the user modifies the first text and the image style type, the target object described in the modified first text may be determined through the process in FIG. 1, the updated second text related to the target object may be acquired in the electronic book, and the updated image generation prompt information may be generated according to the modified first text and the updated second text, where the image style type in the updated image generation prompt information is the image style type obtained by the user through modification in the scenario shown in FIG. 6. Next, the image matching the modified first text and the image style type obtained by the user through modification is generated according to the updated image generation prompt information.

Certainly, the scenario shown in FIG. 6 may also be used as an image generation entry. In the scenario shown in FIG. 6, the user may also delete the first text, re-input a required image generation prompt, select a required image style type, and generate a desired image.

It may be seen that through the embodiments, a strategy of custom image generation by the user is further provided, thereby generating the image matching the user's expectation.

In some embodiments, after the user triggers the paragraph comment entry of the electronic book and enters the paragraph comment page, in response to that the user triggers the "intelligent image generation" control in the paragraph comment page without inputting the comment information, the paragraph for which the user wants to post the comment information may be acquired, the paragraph may be determined as the first text, and the matching image may be generated for the first text.

It may be learned from the previous description that, in some embodiments, after the image generation prompt information is generated, the target image may further be determined, through the image generation model, from the existing images of the electronic book, where the image content of the target image is related to the image content prompted by the image generation prompt information; at least one of the object form of the object in the target image, the image scene environment of the target image, the image composition mode of the target image, the image style type of the target image or the image color hue of the target image may be determined, through the image generation model, as the image reference information; and the image matching the first text may be generated, through the image generation model, according to the image generation prompt information and the image reference information. The above process is shown here through a specific drawing.

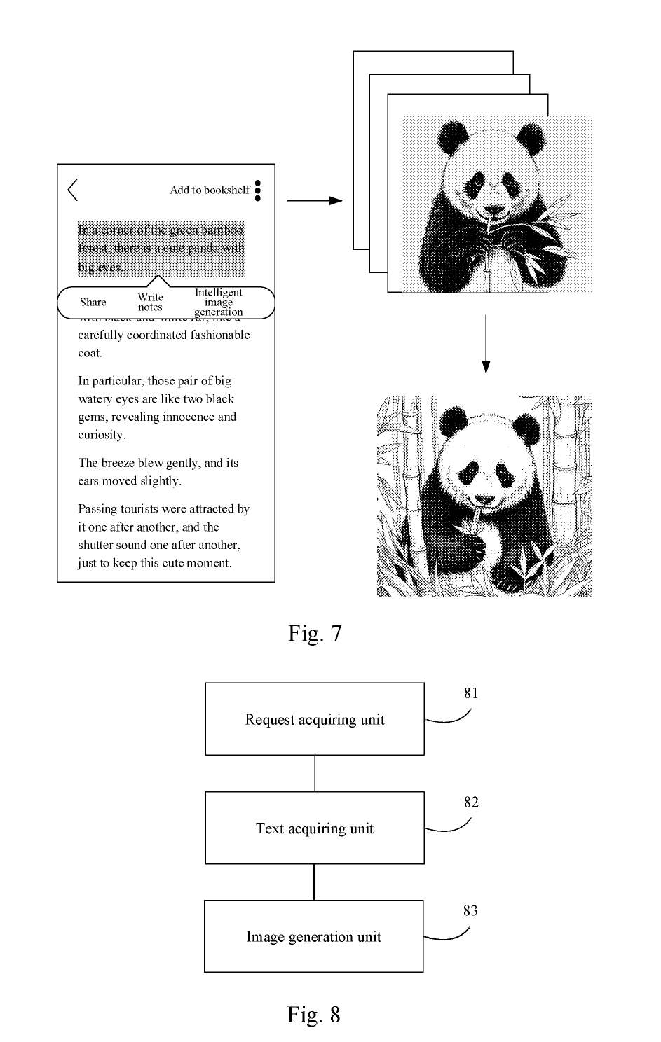

FIG. 7 is a schematic diagram of generating an image matching a first text based on existing images of an electronic book according to an embodiment of the present disclosure. As shown in FIG. 7, the first text is the original text of the electronic book selected by the user in the electronic book. Certainly, the first text may also be the comment information posted by the user for the electronic book, or include the original text of the electronic book selected by the user in the electronic book and the comment information posted by the user for the electronic book. Here, the first text being the original text of the electronic book is used as an example for illustration. The image generation model generates image generation prompt information according to the original text of the electronic book "In a corner of the green bamboo forest, there is a cute panda with big eyes", where the image generation prompt information includes the following elements.

The object form of the object in the image is "a cute panda with big eyes".

The image scene environment is bamboo forest.

The image composition mode is the composition mode with the animal as the main body.

The image style type is cute style.The image color hue is mainly black and white.

As shown in FIG. 7, according to the image content generated and prompted by the image generation prompt information, the image generation model determines, from the existing images of the electronic book (including the cover image of the electronic book, the character image of the electronic book, the comic image corresponding to the electronic book, and the video frame of the short video corresponding to the electronic book), that the target image is the character image of the same panda, in which the panda is eating bamboo. Next, the image generation model generates, according to the target image, a panda eating bamboo in the bamboo forest as the image matching the first text. The image integrates the object form (the panda eating bamboo) of the target image, thereby improving the accuracy of image generation. In FIG. 7, the panda-related schematic diagram is generated by AI.

In summary, through the above embodiments, the first text related to the electronic book may be acquired, the target object described in the first text may be determined, the second text related to the target object may be acquired in the electronic book, and the image matching the first text may be generated according to the first text and the second text, thereby achieving the effect of efficiently and accurately generating an image for the related content of the electronic book.

FIG. 8 is a structural schematic diagram of an image generation apparatus according to an embodiment of the present disclosure. As shown in FIG. 8, the apparatus includes the following units.

A request acquiring unit 81 is configured to acquire an image generation request for a first text, where the first text is a text related to an electronic book.

A text acquiring unit 82 is configured to, in response to the image generation request, determine a target object described in the first text, and acquire a second text related to the target object in the electronic book.

An image generation unit 83 is configured to generate image generation prompt information according to the first text and the second text, and generate an image matching the first text according to the image generation prompt information.

Optionally, the request acquiring unit is further configured to: in response to a selection instruction for a body text part of the electronic book, determine selected content corresponding to the selection instruction in the body text part; and in response to that a first request for generating an image based on the selected content is received, determine the selected content as the first text, and determine the first request as the image generation request for the first text.

Optionally, the request acquiring unit is further configured to: in response to a comment information input instruction for the electronic book, acquire comment information input for the electronic book; and in response to that a second request for generating an image based on the comment information is received, determine the comment information as the first text, and determine the second request as the image generation request for the first text.

Optionally, the text acquiring unit is further configured to: determine a picture scene corresponding to the first text, where the target object is in the picture scene; and acquire, in the electronic book, a first sub-text related to the picture scene and a second sub-text related to an object form of the target object in the picture scene, and determine the first sub-text and the second sub-text as the second text.

Optionally, the text acquiring unit is further configured to: determine a story plot corresponding to the first text, where the target object is in the story plot; and acquire, in the electronic book, a third sub-text related to the story plot and a fourth sub-text related to behavior information of the target object in the story plot, and determine the third sub-text and the fourth sub-text as the second text.

Optionally, the image generation unit is further configured to: determine, through a large language model, element information of image elements according to text content of the first text and text content of the second text, where the image elements include an object form of an object in an image, an image scene environment, an image composition mode, an image style type and an image color hue; and generate, through the large language model, the image generation prompt information according to the element information of the image elements.

Optionally, the image generation unit is further configured to: extract, through the large language model, text content for describing the image elements from the text content of the first text and the text content of the second text to obtain the element information of at least one first image element in the image elements; and expand, through the large language model, for a second image element in the image elements for which the element information is not extracted, to obtain element information of the second image element based on the element information of the first image element and a book type of the electronic book.

Optionally, the image generation unit is further configured to: acquire existing images of the electronic book, where the existing images include at least one a cover image of the electronic book, an illustration image of the electronic book, a character image of the electronic book, a comic image of the electronic book, or an image in a related video of the electronic book; determine, through an image generation model, a target image from the existing images according to the image generation prompt information, where an image content of the target image is related to an image content prompted by the image generation prompt information; and generate, through the image generation model, the image matching the first text according to the image generation prompt information and the target image.

Optionally, the image generation unit is further configured to: determine, through the image generation model, at least one of the object form of the object in the target image, an image scene environment of the target image, an image composition mode of the target image, an image style type of the target image or an image color hue of the target image, as image reference information; and generate, through the image generation model, the image matching the first text according to the image generation prompt information and the image reference information.

Optionally, the above apparatus further includes a custom generation unit, configured to: in response to a custom image generation instruction for the first text, display the first text and an image style type, where the image style type is determined based on the first text and a book type of the electronic book; and in response to a modification instruction for the first text and/or the image style type, generate an image matching the first text according to the modified first text and/or the modified image style type.

The image generation apparatus in the embodiments of the present disclosure may implement each process of the above image generation method embodiments and achieve the same effects and functions, which are not repeated here.

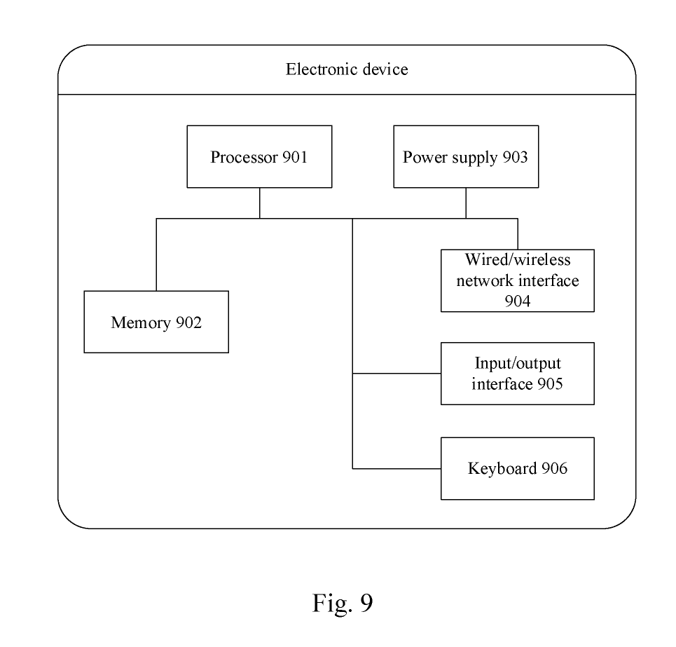

An embodiment of the present disclosure further provides an electronic device. FIG. 9 is a schematic diagram of a structure of an electronic device according to an embodiment of the present disclosure. As shown in FIG. 9, the electronic device may be greatly different due to different configurations or performances, and may include one or more processors 901 and memories 902, and the memory 902 may store one or more applications or data. The memory 902 may be a temporary memory or a persistent memory. The application stored in the memory 902 may include one or more modules (not shown in the figure), and each module may include a series of computer-executable instructions in the electronic device. Furthermore, the processor 901 may be configured to communicate with the memory 902 to execute a series of computer-executable instructions in the memory 902 on the electronic device. The electronic device may further include one or more power supplies 903, one or more wired or wireless network interfaces 904, one or more input or output interfaces 905, one or more keyboards 906, etc.

In a specific embodiment, the electronic device includes a processor; and a memory configured to store computer-executable instructions, where the computer-executable instructions, when executed, cause the processor to implement the following processes.

An image generation request for a first text is acquired, where the first text is a text related to an electronic book.

In response to the image generation request, a target object described in the first text is determined, and a second text related to the target object in the electronic book is acquired.

Image generation prompt information is generated according to the first text and the second text, and an image matching the first text is generated according to the image generation prompt information.

The electronic device in the embodiments of the present disclosure may implement each process of the above image generation method embodiments and achieve the same effects and functions, which are not repeated here.

Another embodiment of the present disclosure further provides a computer-readable storage medium, where the computer-readable storage medium is used to store computer-executable instructions, and the computer-executable instructions, when executed by a processor, implement the following processes.

An image generation request for a first text is acquired, where the first text is a text related to an electronic book;

In response to the image generation request, a target object described in the first text is determined, and a second text related to the target object is acquired in the electronic book.

Image generation prompt information is generated according to the first text and the second text, and an image matching the first text is generated according to the image generation prompt information.

The computer-readable storage medium in the embodiments of the present disclosure may implement each process of the above image generation method embodiments and achieve the same effects and functions, which are not repeated here.

Another embodiment of the present disclosure further provides a computer program product, including a computer program, where the computer program, when executed by a processor, implements the following processes.

An image generation request for a first text is acquired, where the first text is a text related to an electronic book.

In response to the image generation request, a target object described in the first text is determined, and a second text related to the target object is acquired in the electronic book.

Image generation prompt information is generated according to the first text and the second text, and an image matching the first text is generated according to the image generation prompt information.

The computer program product in the embodiments of the present disclosure may implement each process of the above image generation method embodiments and achieve the same effects and functions, which are not repeated here.

In each of the embodiments of the present disclosure, the computer-readable storage medium includes a read-only memory (abbreviated as ROM), a random access memory (abbreviated as RAM), a magnetic disk, an optical disk, etc.

In the 1990s, the improvement of a technology may be clearly distinguished as an improvement on hardware (for example, the improvement of circuit structures such as diodes, transistors, and switches) or an improvement on software (the improvement of a method process). However, with the development of technologies, many improvements of method processes today may be regarded as direct improvements of hardware circuit structures. Designers almost always program improved method processes into hardware circuits to obtain corresponding hardware circuit structures. Therefore, it cannot be said that the improvement of a method process cannot be realized by using a hardware entity module. For example, a programmable logic device (PLD) (such as a field programmable gate array (FPGA)) is such an integrated circuit whose logic function is determined by the user's programming of the device. The designer may program by himself to "integrate" a digital system on a PLD, without having to ask a chip manufacturer to design and manufacture a dedicated integrated circuit chip. Moreover, today, instead of making integrated circuit chips manually, this programming is mostly implemented with "logic compiler" software, which is similar to the software compiler used in program development and writing, and the original code before compilation also has to be written in a specific programming language, which is called a hardware description language (HDL). There is not only one kind of HDL, but many kinds, such as ABEL (Advanced Boolean Expression Language), AHDL (Altera Hardware Description Language), Confluence, CUPL (Cornell University Programming Language), HDCal, JHDL (Java Hardware Description Language), Lava, Lola, MyHDL, PALASM, RHDL (Ruby Hardware Description Language), etc. Currently, the most commonly used are VHDL (Very-High-Speed Integrated Circuit Hardware Description Language) and Verilog. It should also be clear to persons skilled in the art that the hardware circuit for implementing the logical method process may be easily obtained by only performing a little logical programming on the method process with the above several hardware description languages and programming it into the integrated circuit.

The controller may be implemented in any suitable manner, for example, the controller may take the form of a microprocessor or processor and a computer-readable medium storing computer-readable program code (such as software or firmware) executable by the (micro)processor, a logic gate, a switch, an application specific integrated circuit (ASIC), a programmable logic controller, and an embedded microcontroller. Examples of the controller include, but are not limited to, the following microcontrollers: ARC 625D, Atmel AT91SAM, Microchip PIC18F26K20, and Silicone Labs C8051F320. The memory controller may also be implemented as part of the control logic of the memory. Persons skilled in the art also know that, in addition to implementing the controller in a purely computer-readable program code manner, it is entirely possible to logically program the method steps to enable the controller to implement the same functions in the form of a logic gate, a switch, an application specific integrated circuit, a programmable logic controller, an embedded microcontroller, etc. Therefore, such a controller may be considered as a hardware component, and the apparatus included therein for implementing various functions may also be considered as a structure within the hardware component. Alternatively, the apparatus for implementing various functions may even be regarded as both a software module for implementing the method and a structure within a hardware component.

The systems, apparatuses, modules or units illustrated in the above embodiments may be implemented specifically by a computer chip or entity, or by a product having a certain function. A typical implementation device is a computer. Specifically, the computer may be, for example, a personal computer, a laptop computer, a cellular phone, a camera phone, a smart phone, a personal digital assistant, a media player, a navigation device, an email device, a game console, a tablet computer, a wearable device, or a combination of any of these devices.

For the convenience of description, when describing the above apparatus, the functions are divided into various units and described separately. Certainly, when implementing the embodiments of the present disclosure, the functions of the units may be implemented in the same one or more pieces of software and/or hardware.

Persons skilled in the art should understand that one or more embodiments of the present disclosure may be provided as a method, a system or a computer program product. Therefore, one or more embodiments of the present disclosure may take the form of an entirely hardware embodiment, an entirely software embodiment or an embodiment containing both hardware and software elements. Moreover, one or more embodiments of the present disclosure may take the form of a computer program product implemented on one or more computer-usable storage media (including but not limited to disk storage, a CD-ROM, an optical storage, etc.) having computer-usable program code embodied therein.

The present disclosure is described with reference to flowcharts and/or block diagrams of a method, a device (system), and a computer program product according to embodiments of the present disclosure. It should be understood that each process and/or block in the flowcharts and/or block diagrams, and a combination of the processes and/or blocks in the flowcharts and/or block diagrams may be implemented by computer program instructions. These computer program instructions may be provided to a processor of a general-purpose computer, a special-purpose computer, an embedded processor, or other programmable data processing device to generate a machine, so that the instructions executed by the processor of the computer or other programmable data processing device generate an apparatus for implementing a function specified in one or more processes in the flowcharts and/or in one or more blocks in the block diagrams.

These computer program instructions may also be stored in a computer-readable memory capable of guiding the computer or other programmable data processing device to work in a specific manner, so that the instructions stored in the computer-readable memory generate a manufactured product including instruction apparatuses, and the instruction apparatus implements a function specified in one or more processes in the flowcharts and/or in one or more blocks in the block diagrams.

These computer program instructions may also be loaded onto a computer or other programmable data processing device, so that a series of operations and steps are performed on the computer or other programmable device to generate computer-implemented processing, and thus the instructions executed on the computer or other programmable device provide steps for implementing a function specified in one or more processes in the flowcharts and/or in one or more blocks in the block diagrams.

It should also be noted that the terms "include", "include" or any other variation thereof are intended to cover non-exclusive inclusion, so that a process, method, product or device including a series of elements includes not only those elements, but also other elements not explicitly listed or elements inherent to such process, method, product or device. Without further restrictions, an element defined by the phrase "including a..." does not exclude the existence of other identical elements in the process, method, product or device including the element.

One or more embodiments of the present disclosure may be described in the general context of computer-executable instructions executed by a computer, such as program modules. Generally, the program modules include routines, programs, objects, components, data structures, etc. that perform specific tasks or implement specific abstract data types. One or more embodiments of the present disclosure may also be practiced in a distributed computing environment in which tasks are performed by remote processing devices connected through a communication network. In the distributed computing environment, the program modules may be located in local and remote computer storage media including storage devices.

The embodiments in the present disclosure are all described in a progressive manner, and the same and similar parts between the embodiments may be referred to each other. Each embodiment focuses on the differences from other embodiments. In particular, since the system embodiment is basically similar to the method embodiment, the description is relatively simple, and for related parts, reference may be made to the description of the method embodiment.

The above description is only the embodiments of the present disclosure and is not intended to limit the present disclosure. For persons skilled in the art, the present disclosure may have various modifications and changes. Any modification, equivalent replacement, improvement, etc. made within the spirit and principle of the present disclosure shall be included in the scope of the claims of the present disclosure.

1. An image generation method, comprising:
acquiring an image generation request for a first text, wherein the first text is a text related to an electronic book;
determining a first object described in the first text in response to the image generation request, and acquiring a second text related to the first object in the electronic book; and
generating image generation prompt information according to the first text and the second text, and generating an image matching the first text according to the image generation prompt information.

2. The image generation method of claim 1, wherein the acquiring an image generation request for a first text, comprises:
determining selected content corresponding to a selection instruction in a body text part, in response to the selection instruction for the body text part of the electronic book; and
determining the selected content as the first text and determining a first request as the image generation request for the first text, in response to the first request for generating an image based on the selected content.

3. The image generation method of claim 1, wherein the acquiring an image generation request for a first text, comprises:
acquiring comment information input for the electronic book, in response to a comment information input instruction for the electronic book; and
determining the comment information as the first text and determining a second request as the image generation request for the first text, in response to the second request for generating an image based on the comment information.

4. The image generation method of claim 1, wherein the acquiring a second text related to the first object in the electronic book, comprises:
determining a picture scene corresponding to the first text, wherein the first object is in the picture scene; and
acquiring, in the electronic book, a first sub-text related to the picture scene and a second sub-text related to a first form of the first object in the picture scene, and determining the first sub-text and the second sub-text as the second text.

5. The image generation method of claim 1, wherein the acquiring a second text related to the first object in the electronic book, comprises:
determining a story plot corresponding to the first text, wherein the first object is in the story plot; and
acquiring, in the electronic book, a third sub-text related to the story plot and a fourth sub-text related to behavior information of the first object in the story plot, and determining the third sub-text and the fourth sub-text as the second text.

6. The image generation method of claim 1, wherein the generating image generation prompt information according to the first text and the second text, comprises:
determining, through a large language model, element information of image elements according to text content of the first text and text content of the second text, wherein the image elements comprise a first form of an object in an image, an image scene environment, an image composition mode, an image style type, and an image color hue; and
generating, through the large language model, the image generation prompt information according to the element information of the image elements.

7. The image generation method of claim 6, wherein the determining, through a large language model, element information of image elements according to text content of the first text and text content of the second text, comprises:
extracting, through the large language model, text content for describing the image elements from the text content of the first text and the text content of the second text to obtain the element information of at least one first image element in the image elements; and
expanding, through the large language model, for a second image element in the image elements for which the element information is not extracted, to obtain element information of the second image element based on the element information of the first image element and a book type of the electronic book.

8. The image generation method of claim 1, wherein the generating an image matching the first text according to the image generation prompt information, comprises:
acquiring existing images of the electronic book, wherein the existing images comprise at least one of a cover image of the electronic book, an illustration image of the electronic book, a character image of the electronic book, a comic image of the electronic book, or an image in a related video of the electronic book;
determining, through an image generation model, a first image from the existing images according to the image generation prompt information, wherein an image content of the first image is related to an image content prompted by the image generation prompt information; and
generating, through the image generation model, the image matching the first text according to the image generation prompt information and the first image.

9. The image generation method of claim 8, wherein the generating, through the image generation model, the image matching the first text according to the image generation prompt information and the first image, comprises:
determining, through the image generation model, at least one of a first form of an object in the first image, an image scene environment of the first image, an image composition mode of the first image, an image style type of the first image, or an image color hue of the first image, as image reference information; and
generating, through the image generation model, the image matching the first text according to the image generation prompt information and the image reference information.

10. The image generation method of claim 1, further comprising:
displaying the first text and an image style type in response to a custom image generation instruction for the first text, wherein the image style type is determined based on the first text and a book type of the electronic book; and
generating the image matching the first text according to the first text that is modified, in response to a modification instruction for the first text.

11. The image generation method of claim 1, further comprising:
displaying the first text and an image style type in response to a custom image generation instruction for the first text, wherein the image style type is determined based on the first text and a book type of the electronic book; and
generating the image matching the first text according to the image style type that is modified, in response to a modification instruction for the image style type.

12. The image generation method of claim 1, further comprising:
displaying the first text and an image style type in response to a custom image generation instruction for the first text, wherein the image style type is determined based on the first text and a book type of the electronic book; and
generating the image matching the first text according to the first text that is modified and the image style type that is modified, in response to a modification instruction for the first text and the image style type.

13. An electronic device, comprising:
at least a processor; and
a memory configured to store computer-executable instructions, wherein the computer-executable instructions, when executed, cause the processor to implement an image generation method,
wherein the image generation method comprises:
acquiring an image generation request for a first text, wherein the first text is a text related to an electronic book;
determining a first object described in the first text in response to the image generation request, and acquiring a second text related to the first object in the electronic book; and
generating image generation prompt information according to the first text and the second text, and generating an image matching the first text according to the image generation prompt information.

14. The electronic device of claim 13, wherein the acquiring an image generation request for a first text, comprises:
determining selected content corresponding to a selection instruction in a body text part, in response to the selection instruction for the body text part of the electronic book; and
determining the selected content as the first text, and determining a first request as the image generation request for the first text, in response to the first request for generating an image based on the selected content.

15. The electronic device of claim 13, wherein the acquiring an image generation request for a first text, comprises:
acquiring comment information input for the electronic book, in response to a comment information input instruction for the electronic book; and
determining the comment information as the first text, and determining a second request as the image generation request for the first text, in response to the second request for generating an image based on the comment information.

16. The electronic device of claim 13, wherein the acquiring a second text related to the first object in the electronic book, comprises:
determining a picture scene corresponding to the first text, wherein the first object is in the picture scene; and
acquiring, in the electronic book, a first sub-text related to the picture scene and a second sub-text related to a first form of the first object in the picture scene, and determining the first sub-text and the second sub-text as the second text.

17. The electronic device of claim 13, wherein the acquiring a second text related to the first object in the electronic book, comprises:
determining a story plot corresponding to the first text, wherein the first object is in the story plot; and
acquiring, in the electronic book, a third sub-text related to the story plot and a fourth sub-text related to behavior information of the first object in the story plot, and determining the third sub-text and the fourth sub-text as the second text.

18. The electronic device of claim 13, wherein the generating image generation prompt information according to the first text and the second text, comprises:
determining, through a large language model, element information of image elements according to text content of the first text and text content of the second text, wherein the image elements comprise a first form of an object in the image, an image scene environment, an image composition mode, an image style type, and an image color hue; and
generating, through the large language model, the image generation prompt information according to the element information of the image elements.

19. The electronic device of claim 18, wherein the determining, through a large language model, element information of image elements according to text content of the first text and text content of the second text, comprises:
extracting, through the large language model, text content for describing the image elements from the text content of the first text and the text content of the second text to obtain the element information of at least one first image element in the image elements; and
expanding, through the large language model, for a second image element in the image elements for which the element information is not extracted, to obtain element information of the second image element based on the element information of the first image element and a book type of the electronic book.

20. A non-transitory computer-readable storage medium, wherein the computer-readable storage medium is configured to store computer-executable instructions, and the computer-executable instructions, when executed by a processor, implement an image generation method,
wherein the image generation method comprises:
acquiring an image generation request for a first text, wherein the first text is a text related to an electronic book;
determining a first object described in the first text in response to the image generation request, and acquiring a second text related to the first object in the electronic book; and
generating image generation prompt information according to the first text and the second text, and generating an image matching the first text according to the image generation prompt information.
